(19) United States
(12) Patent Application Publication
(10) Pub. No.: US 2024/0256510 A1
(43) Pub. Date: Aug. 1, 2024

(54) DISTRIBUTED FILE SYSTEM ON TOP OF A HYBRID B-EPSILON TREE

(71) Applicant: VMware, Inc., Palo Alto, CA (US)

(72) Inventors: Naama BEN DAVID, Mountain View, CA (US); Aishwarya GANESAN, Champaign, IL (US); Jonathan HOWELL, Seattle, WA (US); Robert T. JOHNSON, Scotts Valley, CA (US); Adriana SZEKERES, Seattle, WA (US)

(21) Appl. No.: 18/160,742

(22) Filed: Jan. 27, 2023

(51) Int. Cl. G06F 16/22; G06F 16/182

(52) U.S. Cl. CPC G06F 16/2246; G06F 16/182

(57) ABSTRACT

A distributed file system operating over a plurality of hosts is built on top of a tree structure having a root node, internal nodes, and leaf nodes. Each host maintains at least one node and non-leaf nodes are allocated buffers according to a workload of the distributed file system. A write operation is performed by inserting write data into one of the nodes of the tree structure having a buffer. A read operation is performed by traversing the tree structure down to a leaf node that stores read target data, collecting updates to the read target data, which are stored in buffers of the traversed nodes, applying the updates to the read target data, and returning the updated read target data as read data.

### BACKGROUND

Distributed file systems today usually target a specific workload. For example, most such file systems assume a small number of very large files that are frequently read with little sharing. Consequently, existing distributed file systems have a rigid design which does not allow for dynamic adjustments to make fundamental trade-offs, for example, read performance vs. write performance, performance vs. scalability, etc. In addition, none of the existing distributed file systems have been designed for disaggregated clusters and, consequently, do not offer the best resource allocation strategies.

### SUMMARY

Embodiments provide a distributed file system that is built on top of a tree structure and is deployed across a plurality of host computer systems. A method for operating the distributed file system includes the steps of: forming a tree structure, the tree structure having a plurality of nodes including a root node at an uppermost level, internal nodes below the root node, and leaf nodes containing data items, each of the root node and the internal nodes including pivot keys and pointers to at least one child node or at least one leaf node, wherein each of the host computer systems maintains at least one of the nodes and non-leaf nodes are allocated buffers according to a workload of the distributed file system; performing a write operation on a file in the distributed file system by inserting first data specified in the write operation as write data into one of the nodes of the tree structure having a buffer; and performing a read operation on a file in the distributed file system by traversing the tree structure down to a leaf node that stores second data, collecting updates to the second data, which are stored in buffers of the nodes that are traversed, applying the collected updates to the second data, and returning the updated second data as read data.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 depicts a plurality of host computer systems over which a distributed file system according to embodiments operates.

FIG. 2 depicts nodes of a tree structure on top of which the distributed file system is built.

FIG. 3 depicts data fields of a node of the tree structure.

FIG. 4 depicts a table relating file operations of the distributed file system to tree operations.

FIG. 5 depicts a point query operation carried out on the tree according to embodiments.

FIG. 6 depicts an insert operation carried out on the tree according to embodiments.

FIG. 7 depicts tree traversal carried out during the point query operation.

FIG. 8 depicts tree traversal carried out during the insert operation.

### DETAILED DESCRIPTION

In the embodiments, a distributed file system is built on top of a tree data structure that is a modified version of a Bε-tree by mapping file system operation to one or more operations on the modified Bε-tree (hereinafter referred to as the hybrid Bε-tree). In the hybrid Bε-tree of the embodiments, the position of dividing lines between upper-level nodes which do not have buffers and lower-level nodes which have buffers are dynamically adjustable. Adjusting the position of these dividing lines alters the trade-off between scalability, the performance of read operations, and the performance of write operations, thereby allowing the distributed file system that is built on top of this hybrid Bε-tree to adapt to more diverse workloads.

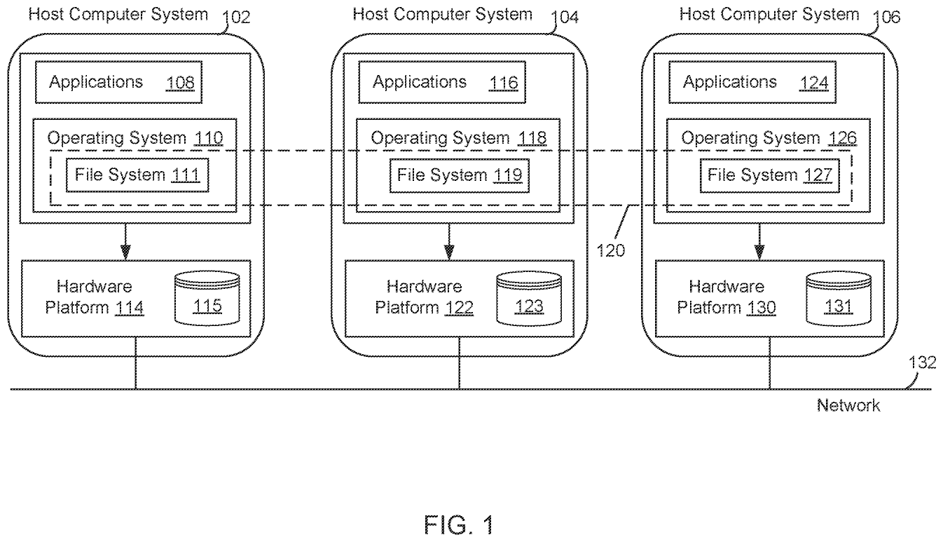

FIG. 1 depicts host computer systems 102, 104, 106 interconnected via a network 132, across which a distributed file system according to embodiments, namely distributed file system 120, may be implemented. Each of host computer systems 102, 104, 106 has a corresponding hardware platform (hardware platforms 114, 122, 130, respectively) and a corresponding operating system (operating systems 110, 118, 126, respectively), and runs applications therein (applications 108, 116, 124, respectively) on top of their respective operating systems. In the example of FIG. 1, three host computer systems are depicted but that is for illustration only and the number of host computer systems across which distributed file system 120 is implemented may be two or greater than three.

Each of operating systems 110, 118, 126 has a corresponding file system (file systems 111, 119, 127, respectively), which includes a file system driver and data structures maintained by the file system driver. The file system controls how data is stored in a storage device of its corresponding hardware platform, e.g., storage device 115 of hardware platform 114, storage device 123 of hardware platform 122, and storage device of hardware platform 130. Examples of the storage device include a hard disk drive or a solid state drive. In the embodiments, the file system drivers cooperate with each other such that a request for data in distributed file system 120 occurring in one host computer system may be fetched from a local storage device or from another host computer system.

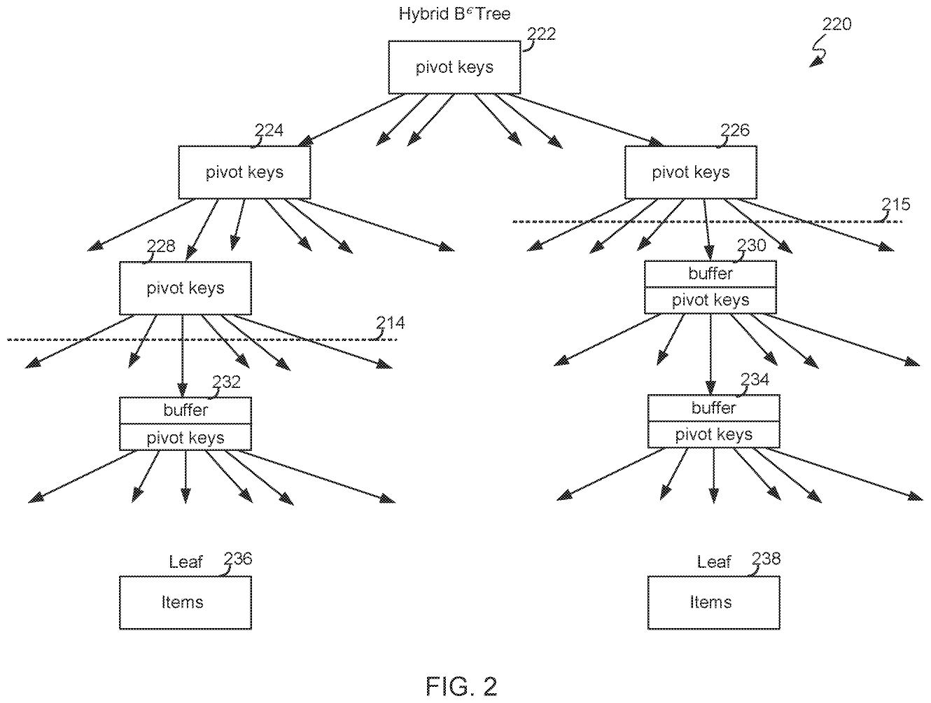

In the embodiments, distributed file system 120 is built on top of a hybrid Bε-tree by mapping every file system operation to one or more operations on the hybrid Bε-tree. FIG. 2 depicts one example of the hybrid Bε-tree as tree 220. Each non-leaf node in tree 220 includes a set of pivot keys and a set of child pointers. In addition, each non-leaf node may include a buffer depending on the workload of distributed file system 120. Leaf nodes of tree 220, which are at the bottom, contain items.

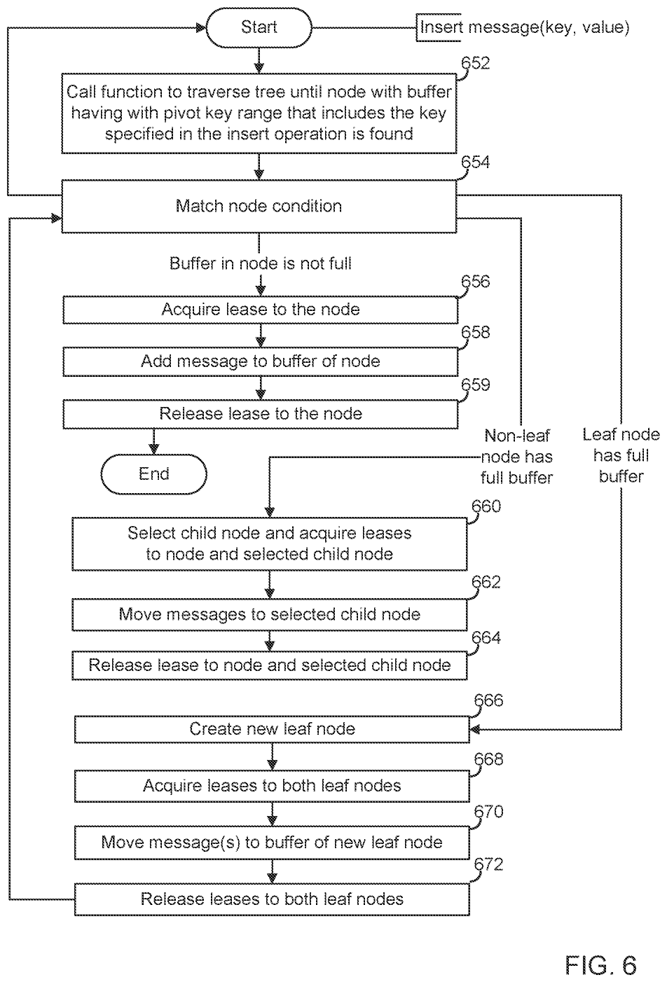

In tree 220 depicted in FIG. 2, nodes 222, 224, 226, 228 are upper-level nodes that do not have a buffer, whereas nodes 230, 232, 234 are lower-level nodes that include a buffer. The position of dividing line 214 between node 228 and node 232 and the position of dividing line 215 between node 226 and node 230 are dynamically adjustable as described below in conjunction with FIG. 6. Adjusting the position of these dividing lines alters the trade-off between scalability, the performance of read operations, and the performance of write operations, thereby allowing distributed file system 120 that is built on top of tree 220 to adapt to more diverse workloads. For example, when there is high contention on the buffered data at a lower-level node, the dividing line is moved downwards, so that the node becomes an upper-level node and contention is now spread across child nodes of that upper-level node. On the other hand, when an operation (e.g., clone) requires buffering of updates at an upper-level node, the dividing line is moved upwards so that the node becomes a lower-level node that is capable of buffering. In one embodiment, a policy that is based on workload behavior may be defined and enforced to move the dividing line upwards or downwards. For example, one more of the dividing lines may be moved upwards when a bulk rename operation is carried out, and moved downwards when many clients of distributed file system 120 are contending over writes to a common ancestor node.

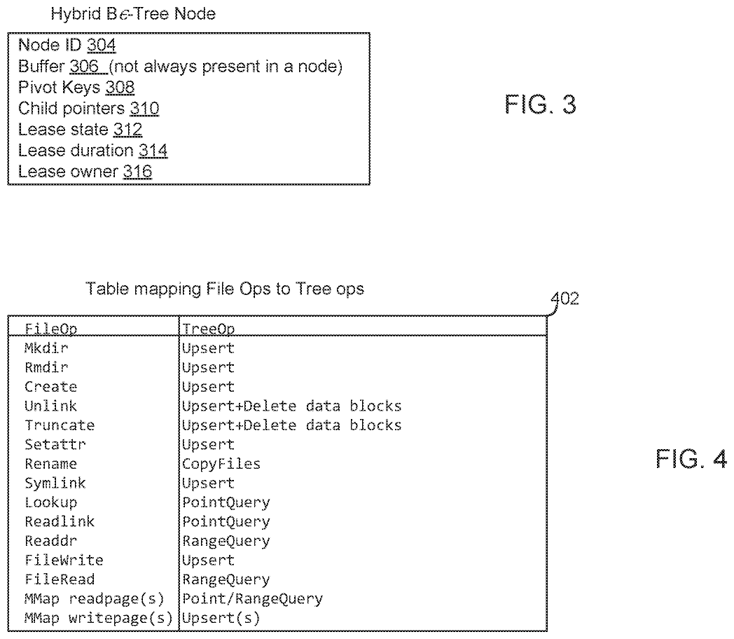

FIG. 3 depicts data fields of a node of a hybrid Bε-tree. They include data fields for node ID 304, pivot keys 308, child pointers 310, lease state 312, lease duration 314, and lease owner 316. Node ID 303 is a concatenation of an identifier of the host computer system in which the node is located (host ID) and a virtual address assigned to that node by the host computer system. Pivot keys 308 are keys used to determine routing destinations. Child pointers 310 are pointers to child nodes that are routing destinations determined from pivot keys 308.

In the embodiments, nodes may be locked using leases, and lease state 312 indicates whether a host computer system has acquired a lease and the type of lease that has been acquired. The type of lease may be read-shared or write-exclusive. Lease duration 314 indicates the duration of the lease, in particular the expiration date/time for the lease. Lease owner 316 identifies the host computer system (with the host ID thereof) that has acquired the lease. When a host computer system attempts to acquire a read-shared lease to a particular node and the lease is not available because another host computer has a write-exclusive lease to the node, the host computer system retries at a later time that is guided by the lease duration. When a host computer system attempts to acquire a write-exclusive lease to a particular node and the lease is not available because another host computer has a write-exclusive lease to the node or one or more other host computers have a read-shared lease to the node, the host computer system retries at a later time that is guided by the lease durations. If the lease is available, the host computer system acquires the lease by writing its host ID into the data field for lease owner 316.

In the embodiments, leases are used to lock a node when a structural update to the tree occurs, such as creating a new child node or splitting a node. Leases may also be used to control contention for concurrent operations on the nodes due to multiple host computer systems having independent access to the nodes. In other embodiments, concurrency control can be implemented with atomic operations on the nodes.

Some nodes also include a buffer 306. Buffer 306 represents a location in storage for buffering writes. As will be described below, writes are stored in buffer 306 as key-value pairs, where the key is associated with a target of the write operation (e.g., a file location or a location within a file) and the value is a message that encodes updates to data stored at the target. In the embodiments, upper-level nodes do not have a buffer. Also, leaf nodes do not have pivot keys and child pointers. In addition, each node of the hybrid Bε-tree resides in and is maintained by one of the host computer systems across which distributed file system 120 is implemented.

FIG. 4 depicts a table relating file operations of distributed file system 120 to Bε-tree operations. Building distributed file system 120 on top of a hybrid Bε-tree means that file system operations are translated to tree operations of the hybrid Bε-tree. As shown, most file operations translate to upsert, point query, or range query operations on the tree.

Tree operations of the hybrid Bε-tree involve a key, which logically represents a file or directory path, and the key maps to a location in distributed file system 120, e.g., an address of a file block and an offset. A query operation involves a traversal of the hybrid Bε-tree to find a node that matches a key that is submitted with the query. A point query operation (PointQuery in FIG. 4) works on a single key while a range query operation (RangeQuery in FIG. 4) works on a range of keys. In the embodiments, a read operation performed on a single location in distributed file system 120, which is mapped to a key, translates into a point query operation.

An upsert operation is a special form of an insert operation. The insert operation is performed on a message that is in the form of a key-value pair, where the key is used to find a node in which the message is to be inserted. In the embodiments, a write operation performed on a location in distributed file system 120 translates into an insert operation, where the key maps to the location in distributed file system 120 and the value encodes updates to data stored at the target location. With an upsert operation, an upsert message is inserted into the node. The upsert message contains (k, (f, Δ)) where k is the key, f is a callback function, and Δ is auxiliary data specifying the update to be performed. An upsert operation can be used to implement a file system operation known as read-modify-write. In the embodiments, an update to an entire file block translates to an insert operation whereas a partial block modification translates into an upsert operation.

Some file operations of distributed file system 120 that must be atomic may involve multiple Bε-tree operations. For example, file renames and file creates each involve a range query and upsert operations. To enable this, Bε-tree exposes a transaction API to distributed file system 120.

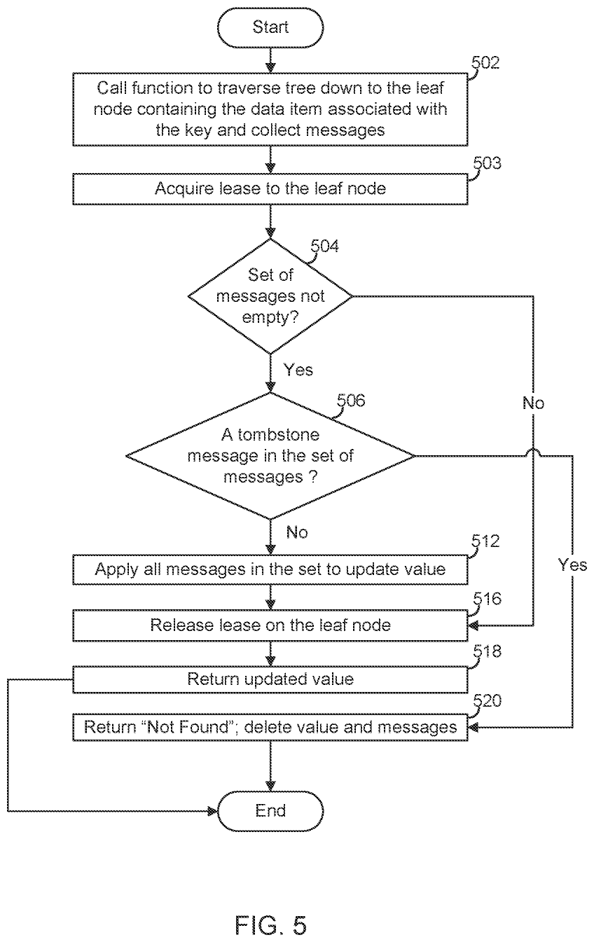

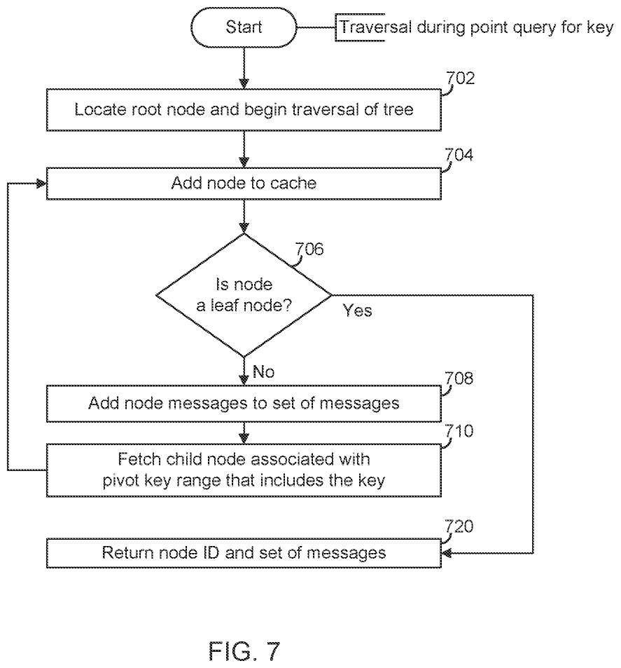

FIG. 5 depicts a point query operation carried out on the hybrid Bε-tree, according to embodiments. The point query operation depicted in FIG. 5 is carried out, for example, when a read operation is performed in distributed file system 120, and is performed by one of the host computer systems that have implemented distributed file system 120. The host computer system that is carrying out this point query operation is referred to herein as a local host and other host computer systems are referred to as remote hosts. Step 502 represents call of a function to traverse the tree using a key that maps to the read target location in distributed file system 120, cache nodes that are fetched during the traversal in the memory of the local host, and collect messages during the traversal. The function called in step 502 is described below in conjunction with FIG. 7.

In step 503, the local host acquires a read-shared lease to the leaf node containing the value associated with the key. If the lease is not available, the local host waits until the expiration of the lease before trying again. If the lease is available, the local host acquires the lease, e.g., by writing its host ID into data field for lease owner 316 of the leaf node.

The processing of messages associated with the key begins in step 504. If there are no such messages (step 504, No), the local host in step 516 releases the lease on the leaf node, and in step 518 returns the value associated with the key, which is stored in the leaf node. If one of the messages is a tombstone message, which is a message to delete a value associated with a key (step 506, Yes), the operation returns ‘Not Found’ and deletes the value in the leaf node along with the tombstone message and any other collected messages that are stored in their respective buffers in step 520.

If there is no tombstone message in the collected messages (step 506, No), the local hosts updates the value associated with the key that is stored in the leaf node by applying the collected messages to the value (step 512). Then, the local host in step 516 releases the lease on the leaf node, and in step 518 returns the updated value.

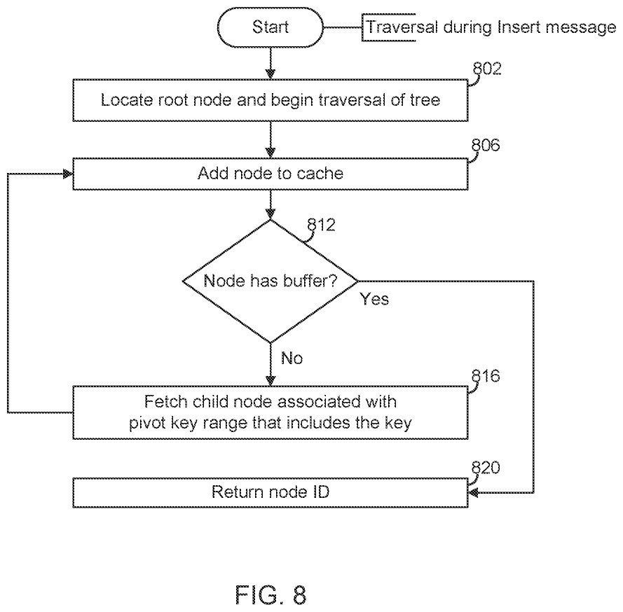

FIG. 6 depicts an insert operation carried out on the hybrid Bε-tree, according to embodiments. The insert operation depicted in FIG. 6 is carried out, for example, when a write operation is performed in distributed file system 120, and is performed by any one of the host computer systems that have implemented distributed file system 120. The insert operation is performed on a message that specifies a key-value pair, where the key maps to a write target location in distributed file system 120 and the value encodes updates to data stored at the target location. The host computer system that is carrying out this insert operation is referred to herein as a local host and other host computer systems are referred to as remote hosts. Step 652 represents call of a function to traverse the tree using a key that maps to the write target location in distributed file system 120 and cache nodes that are fetched during the traversal in the memory of the local host. The function called in step 652 is described below in conjunction with FIG. 8.

When the node with a buffer is found in step 652, the local host checks the condition of the node in step 654. If the buffer in the node is not full (i.e., has available space to absorb the message), it acquires a write-exclusive lease to the node in step 656, inserts the message to the buffer of the node in step 658, and releases the lease to the node in step 659. The operation ends after step 659.

If the buffer in the node is full, step 660 is carried out for a non-leaf node and step 666 is carried out next for a leaf node. In step 660, the local host selects a child node having available buffer space into which messages currently stored in the full buffer of the node can be moved, and acquires write-exclusive leases to the node and to the selected child node. Then, the local host moves the messages to the selected child node in step 662. In step 664, the leases acquired in step 660 are released. After step 664, the flow returns to step 654 for the local host to check the condition of the node and proceeds to execute steps 656, 658, and 659 described above if the buffer in the node is no longer full.

If the node is a leaf node and its buffer is full, then the leaf node is split in step 666, creating a new leaf node. The new leaf node is randomly assigned to one of the host computer systems, and pivot keys and child pointers in the parent node are modified accordingly. In step 668, the local host acquires a write-exclusive lease to both leaf nodes, and in step 670, moves one or more messages to the new leaf node. In step 672, the leases acquired in step 668 are released. After step 672, the flow returns to step 654 for the local host to check the condition of the node and proceeds to execute steps 656, 658, and 659 described above if the buffer in the node is no longer full.

FIG. 7 depicts steps carried out by the function called in step 502 described above. The local host in step 702 locates the root node and begins traversal of the tree using the key specified in the function call. As the tree is traversed node by node, the local host adds the current node that is traversed to its cache (e.g., its memory) in step 704. In step 706, the local host checks to see if it has reached a leaf node. If the node traversed is a leaf node (Step 706, Yes), its node ID and a set of collected messages is returned in step 720. If the node traversed is not a leaf node (Step 706, No), in step 708, any message in the buffer of the node that is associated with the key specified in the function call is collected, i.e., added to a set of messages to be returned. Then, the local host compares the pivot keys stored in the node against the key specified in the function call to retrieve the child pointer associated with the child node that is to be traversed next, and in step 710 fetches the child node using the child pointer. Flow then returns to step 704 with the fetched child node as the current node that is traversed. During the tree traversal, because the nodes of the tree may reside in any of the host computer systems, the local host may need to fetch nodes from remote hosts if they do not reside in or are not cached in the local host. In addition, the local host acquires a read-shared lease for every node encountered in the tree traversal to protect the entire path of the tree traversal.

FIG. 8 depicts steps carried out by the function called in step 652 described above to find the target node having a buffer. The local host in step 802 locates the root node and begins traversal of the tree using the key specified in the function call. As the tree is traversed node by node, the local host adds the current node that is traversed to its cache (e.g., its memory) in step 806. If the node has a buffer (Step 812, Yes), its node ID is returned in step 820. If the node does not have a buffer (Step 812, No), the local host compares the pivot keys stored in the node against the key specified in the function call to retrieve the child pointer associated with the child node that is to be traversed next, and in step 816 fetches the child node using the child pointer. Flow then returns to step 806 with the fetched child node as the current node that is traversed. During the tree traversal, because the nodes of the tree may reside in any of the host computer systems, the local host may need to fetch nodes from remote hosts if they do not reside in or are not cached in the local host. In addition, the local host acquires a read-shared lease for every node encountered in the tree traversal until the target node is found.

Certain embodiments as described above involve a hardware abstraction layer on top of a host computer. The hardware abstraction layer allows multiple contexts to share the hardware resource. These contexts are isolated from each other in one embodiment, each having at least a user application program running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application program runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers, each including an application program and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application program's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained only to use a defined amount of resources such as CPU, memory, and I/O.

Certain embodiments may be implemented in a host computer without a hardware abstraction layer or an OS-less container. For example, certain embodiments may be implemented in a host computer running a Linux® or Windows® operating system.

The various embodiments described herein may be practiced with other computer system configurations, including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system. Computer-readable media may be based on any existing or subsequently developed technology for embodying computer programs in a manner that enables them to be read by a computer. Examples of a computer-readable medium include a hard drive, network-attached storage (NAS), read-only memory, random-access memory (e.g., a flash memory device), a CD (Compact Discs)—CD-ROM, a CDR, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for operating a distributed file system over a plurality of host computer systems, the method comprising:
forming a tree structure, the tree structure having a plurality of nodes including a root node at an uppermost level, internal nodes below the root node, and leaf nodes containing data items, each of the root node and the internal nodes including pivot keys and pointers to at least one child node or at least one leaf node, wherein each of the host computer systems maintains at least one of the nodes and non-leaf nodes are allocated buffers according to a workload of the distributed file system;
performing a write operation on a file in the distributed file system by inserting first data specified in the write operation as write data into one of the nodes of the tree structure having a buffer; and
performing a read operation on a file in the distributed file system by traversing the tree structure down to a leaf node that stores second data, collecting updates to the second data, which are stored in buffers of the nodes that are traversed, applying the collected updates to the second data, and returning the updated second data as read data.

2. The method of claim 1, wherein the step of performing the write operation further includes:
traversing the tree structure using a key associated with a location in the distributed file system to which the first data is to be written; and
inserting a message that is associated with the key and contains the first data, into a highest node of the tree structure having a buffer that is traversed.

3. The method of claim 2, wherein the tree structure is traversed according to a comparison of the key with pivot keys stored in each traversed node and the child pointers stored in each traversed node, each of the child pointers containing an identifier of one of the host computer systems.

4. The method of claim 3, further comprising:
caching the traversed nodes locally in the host computer system that is performing the write operation.

5. The method of claim 2, further comprising:
prior to inserting the message into a node that is the highest node of the tree structure having a buffer that is traversed, acquiring a lease to the node for the host computer system that is performing the write operation so that no other host computer system can access the node.

6. The method of claim 1, wherein
the tree structure is traversed during the read operation using a key that is associated with a location in the distributed file system from which the read data is to be read, and
the tree structure is traversed according to a comparison of the key with pivot keys stored in each traversed node and the child pointers stored in each traversed node, each of the child pointers containing an identifier of one of the host computer systems.

7. The method of claim 6, further comprising:
caching the traversed nodes locally in the host computer system that is performing the read operation.

8. The method of claim 1, further comprising:
deallocating a buffer from a first non-leaf node of the tree structure and allocating a buffer to a second non-leaf node of the tree structure according to a policy that is based on workload behavior.

9. The method of claim 8, wherein
the buffer previously allocated to the first non-leaf node is deallocated from the first non-leaf node in response to write contention on the first non-leaf node, and the second non-leaf node is one a plurality of non-leaf nodes that are allocated buffers in preparation for a bulk rename operation.

10. A computer system comprising:
a plurality of host computer systems over which a distributed file system operates, the distributed file system including a file system in each of the host computer systems that coordinates with file systems of other host computer systems to maintain nodes of a tree structure, wherein the tree structure has a plurality of nodes including a root node at an uppermost level, internal nodes below the root node, and leaf nodes containing data items, each of the root node and the internal nodes including pivot keys and pointers to at least one child node or at least one leaf node, wherein non-leaf nodes are allocated buffers according to a workload of the distributed file system and each of the file systems is configured to:
perform a write operation on a file in the distributed file system by inserting first data specified in the write operation as write data into one of the nodes of the tree structure having a buffer; and
perform a read operation on a file in the distributed file system by traversing the tree structure down to a leaf node, collecting updates to the second data, which are stored in buffers of the nodes that are traversed, applying the collected updates to the second data, and returning the updated second data as read data.

11. The computer system of claim 10, wherein each of the file systems is configured to perform the write operation by:
traversing the tree structure using a key associated with a location in the distributed file system to which the first data is to be written; and
inserting a message that is associated with the key and contains the first data, into a highest node of the tree structure having a buffer that is traversed.

12. The computer system of claim 11, wherein the tree structure is traversed according to a comparison of the key with pivot keys stored in each traversed node and the child pointers stored in each traversed node, each of the child pointers containing an identifier of one of the host computer systems.

13. The computer system of claim 10, wherein
the tree structure is traversed during the read operation using a key that is associated with a location in the distributed file system from which the read data is to be read, and
the tree structure is traversed according to a comparison of the key with pivot keys stored in each traversed node and the child pointers stored in each traversed node, each of the child pointers containing an identifier of one of the host computer systems.

14. The computer system of claim 10, wherein
a buffer previously allocated to a first non-leaf node is deallocated from the first non-leaf node in response to write contention on the first non-leaf node, and a second non-leaf node is allocated a buffer in preparation for a bulk rename operation.

15. A non-transitory computer readable medium comprising instructions executable in each of plurality of host computer systems, wherein the instructions, when executed in the host computer systems, cause the host computer systems to carry out a method of operating a distributed file system over the plurality of host computer systems, the method comprising:
forming a tree structure, the tree structure having a plurality of nodes including a root node at an uppermost level, internal nodes below the root node, and leaf nodes containing data items, each of the root node and the internal nodes including pivot keys and pointers to at least one child node or at least one leaf node, wherein each of the host computer systems maintains at least one of the nodes and non-leaf nodes are allocated buffers according to a workload of the distributed file system;
performing a write operation on a file in the distributed file system by inserting first data specified in the write operation as write data into one of the nodes of the tree structure having a buffer; and
performing a read operation on a file in the distributed file system by traversing the tree structure down to a leaf node that stores second data, collecting updates to the second data, which are stored in buffers of the nodes that are traversed, applying the collected updates to the second data, and returning the updated second data as read data.

16. The non-transitory computer readable medium of claim 15, wherein the step of performing the write operation further includes:
traversing the tree structure using a key associated with a location in the distributed file system to which the first data is to be written; and
inserting a message that is associated with the key and contains the first data, into a highest node of the tree structure having a buffer that is traversed, wherein
the tree structure is traversed according to a comparison of the key with pivot keys stored in each traversed node and the child pointers stored in each traversed node, each of the child pointers containing an identifier of one of the host computer systems.

17. The non-transitory computer readable medium of claim 16, wherein the method further comprises:
caching the traversed nodes locally in the host computer system that is performing the write operation.

18. The non-transitory computer readable medium of claim 15, wherein
the tree structure is traversed during the read operation using a key that is associated with a location in the distributed file system from which the read data is to be read, and
the tree structure is traversed according to a comparison of the key with pivot keys stored in each traversed node and the child pointers stored in each traversed node, each of the child pointers containing an identifier of one of the host computer systems.

19. The non-transitory computer readable medium of claim 18, wherein the method further comprises:
caching the traversed nodes locally in the host computer system that is performing the read operation.

20. The non-transitory computer readable medium of claim 16, wherein
a buffer previously allocated to a first non-leaf node is deallocated from the first non-leaf node in response to write contention on the first non-leaf node, and a second non-leaf node is allocated a buffer in preparation for a bulk rename operation.
